(19) United States
(12) Patent Application Publication
(10) Pub. No.: US 2025/0337046 A1
(43) Pub. Date: Oct. 30, 2025

(54) IMMERSION COOLING SYSTEMS AND METHODS FOR TRACTION BATTERY PACK SYSTEMS

(71) Applicant: FORD GLOBAL TECHNOLOGIES, LLC, Dearborn, MI (US)

(72) Inventor: Xiaogang ZHANG, Novi, MI (US)

(21) Appl. No.: 18/648,896

(22) Filed: Apr. 29, 2024

(51) Int. Cl. H01M 10/6568; B60L 50/60; H01M 10/613; H01M 10/625; H01M 50/209; H01M 50/249; H01M 50/358

(52) U.S. Cl. CPC H01M 10/6568; H01M 10/613; H01M 10/625; H01M 50/209; H01M 50/249; H01M 50/358; B60L 50/60; H01M 2220/20

(57) ABSTRACT

Immersion cooling systems are provided for managing thermal energy levels within a traction battery pack system. An exemplary immersion cooling system may include an injection shield arranged to subdivide an interior volume of a battery enclosure assembly into a first interior volume section and a second interior volume section. The injection shield may include a plurality of injection holes configured to spray a cooling fluid (e.g., a dielectric fluid) onto portions of a battery module that is housed within the second interior volume section. The immersion cooling system may additionally include a fluid manifold extending outside of the interior volume of the battery enclosure assembly, and one or more runner pipes that fluidly connect the fluid manifold to the second interior volume section. Together, the fluid manifold and the runner pipe may establish a dedicated vent gas exit flow path for expelling battery vent byproducts from the enclosure assembly during a battery thermal event.

### TECHNICAL FIELD

This disclosure relates generally to electrified vehicle traction battery pack systems, and more particularly to immersion cooling systems capable of managing battery cell thermal energy levels within traction battery pack systems.

### BACKGROUND

An electrified vehicle includes a traction battery pack for powering electric machines and other electrical loads of the vehicle. The traction battery pack includes a plurality of battery cells and various other battery internal components that support electric vehicle propulsion.

### SUMMARY

A traction battery pack system according to an exemplary aspect of the present disclosure includes, among other things, an enclosure assembly that provides an interior volume, an injection shield arranged to subdivide the interior volume of the enclosure assembly into a first interior volume section and a second interior volume section, and a battery module housed within the second interior volume section. The injection shield includes a plurality of injection holes configured to spray a cooling fluid onto portions of the battery module.

In a further non-limiting embodiment of the foregoing traction battery pack system, the cooling fluid is a dielectric fluid.

In a further non-limiting embodiment of either of the foregoing traction battery pack systems, a fluid manifold extends outside of the interior volume of the enclosure assembly.

In a further non-limiting embodiment of any of the foregoing traction battery pack systems, a runner pipe fluidly connects the fluid manifold to the second interior volume section.

In a further non-limiting embodiment of any of the foregoing traction battery pack systems, the fluid manifold and the runner pipe cooperate to establish a dedicated vent gas exit flow path for expelling a battery vent byproduct from the enclosure assembly during a battery thermal event.

In a further non-limiting embodiment of any of the foregoing traction battery pack systems, the plurality of injection holes are configured to spray the cooling fluid onto top surfaces of a plurality of battery cells of the battery module.

In a further non-limiting embodiment of any of the foregoing traction battery pack systems, the interior volume is part of a closed loop cooling circuit of an immersion cooling system configured for circulating the cooling fluid.

In a further non-limiting embodiment of any of the foregoing traction battery pack systems, the immersion cooling system includes an inlet pipe fluidly connected to the first interior volume section, and an outlet pipe fluidly connected to the second interior volume section.

In a further non-limiting embodiment of any of the foregoing traction battery pack systems, the immersion cooling system includes a liquid-gas separator fluidly connected to the outlet pipe, and a reservoir fluidly connected to the inlet pipe.

In a further non-limiting embodiment of any of the foregoing traction battery pack systems, a heat exchanger is arranged between the reservoir and the inlet pipe.

A traction battery pack system according to another exemplary aspect of the present disclosure includes, among other things, a battery pack assembly including a battery module housed within an enclosure assembly, and an injection shield arranged to subdivide an interior volume of the enclosure assembly into a first interior volume section and a second interior volume section. The battery module is housed within the second interior volume section, a fluid manifold extends outside of the interior volume of the enclosure assembly, and a runner pipe fluidly connects the fluid manifold to the second interior volume section.

In a further non-limiting embodiment of the foregoing traction battery pack system, the fluid manifold and the runner pipe cooperate to establish a dedicated vent gas exit flow path for expelling a battery vent byproduct from the battery pack assembly during a battery thermal event.

In a further non-limiting embodiment of either of the foregoing traction battery pack systems, the injection shield is positioned between an enclosure cover of the enclosure assembly and a top surface of the battery module.

In a further non-limiting embodiment of any of the foregoing traction battery pack systems, an inlet pipe is fluidly connected to the first interior volume section, and an outlet pipe is fluidly connected to the second interior volume section.

In a further non-limiting embodiment of any of the foregoing traction battery pack systems, a reservoir is fluidly connected to the inlet pipe.

In a further non-limiting embodiment of any of the foregoing traction battery pack systems, a pump is arranged between the reservoir and the inlet pipe.

In a further non-limiting embodiment of any of the foregoing traction battery pack systems, a heat exchanger is arranged between the pump and the reservoir.

In a further non-limiting embodiment of any of the foregoing traction battery pack systems, a liquid-gas separator is fluidly connected to the outlet pipe.

In a further non-limiting embodiment of any of the foregoing traction battery pack systems, the liquid-gas separator is fluidly connected to the fluid manifold.

In a further non-limiting embodiment of any of the foregoing traction battery pack systems, the liquid-gas separator is fluidly connected to a reservoir.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 schematically illustrates a traction battery pack system that includes an immersion cooling system.

FIG. 3 is a cross-sectional view through section 3-3 of FIG. 2.

FIG. 4 schematically illustrates operation of the immersion cooling system of FIGS. 2 and 3 during a battery thermal event.

### DETAILED DESCRIPTION

This disclosure details immersion cooling systems for managing thermal energy levels within a traction battery pack system. An exemplary immersion cooling system may include an injection shield arranged to subdivide an interior volume of a battery enclosure assembly into a first interior volume section and a second interior volume section. The injection shield may include a plurality of injection holes configured to spray a cooling fluid (e.g., a dielectric fluid) onto portions of a battery module that is housed within the second interior volume section. The immersion cooling system may additionally include a fluid manifold extending outside of the interior volume of the enclosure assembly, and one or more runner pipes that fluidly connect the fluid manifold to the second interior volume section. Together, the fluid manifold and the runner pipe may establish a dedicated vent gas exit flow path for expelling battery vent byproducts from the battery enclosure assembly during a battery thermal event. These and other features are discussed in greater detail in the following paragraphs of this detailed description.

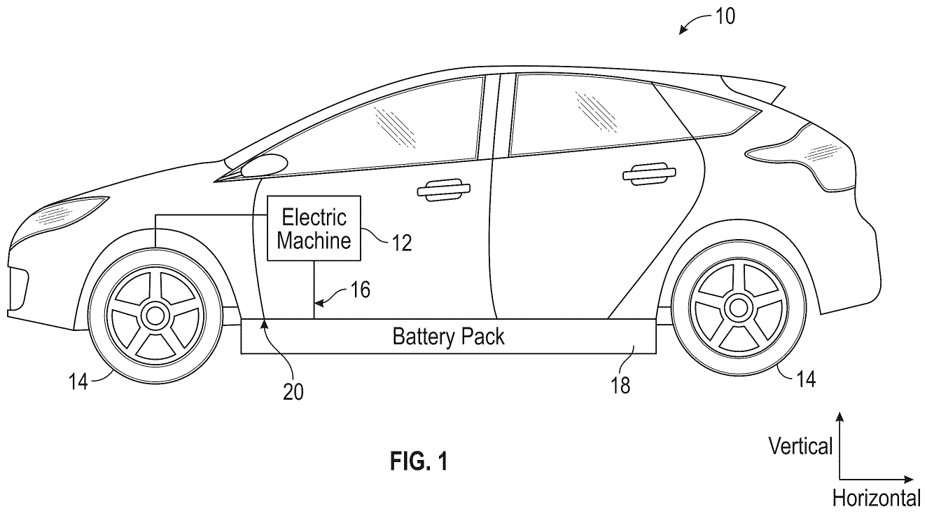

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack system 18. The traction battery pack system 18 is an exemplary electrified vehicle battery. The traction battery pack system 18 may include a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack system 18 may be secured to an underbody 20 of the electrified vehicle 10. However, the traction battery pack system 18 could be located elsewhere on the electrified vehicle 10 within the scope of this disclosure.

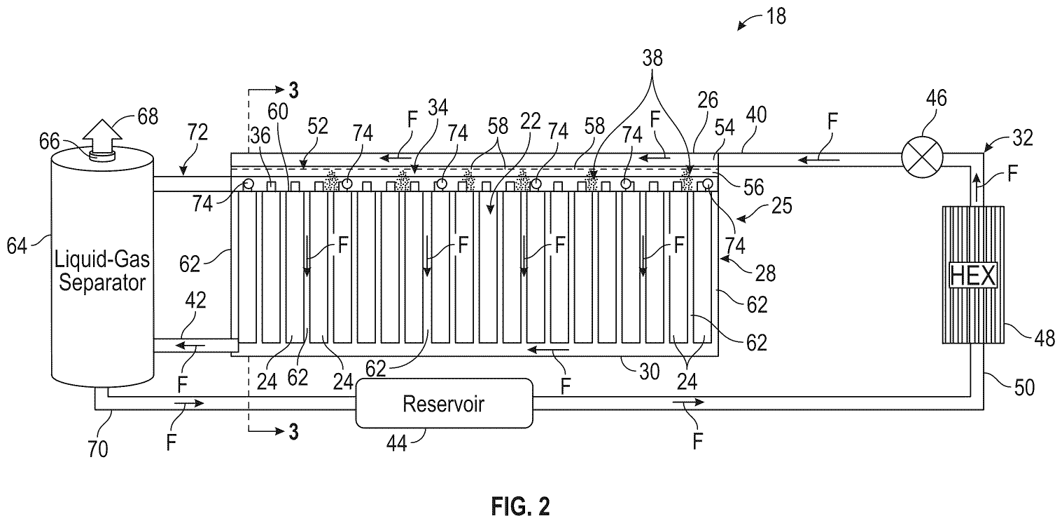

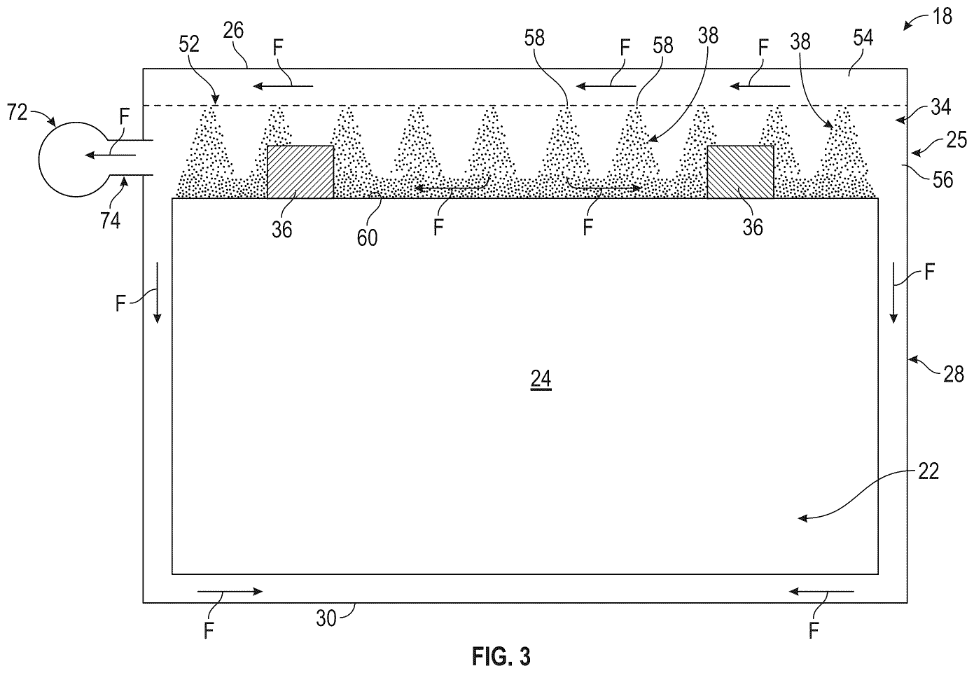

FIGS. 2 and 3 illustrate additional details associated with the traction battery pack system 18 of the electrified vehicle 10 of FIG. 1. The traction battery pack system 18 may include one or more battery modules 22 (e.g., battery assemblies or groupings of rechargeable battery cells 24) capable of outputting electrical power to power the electric machine 12 and/or other electrical loads of the electrified vehicle 10.

The battery cells 24 may be stacked side-by-side along a stack axis to construct a grouping of battery cells 24, sometimes referred to as a “cell stack.” The total number of battery modules 22 and battery cells 24 provided within the traction battery pack system 18 is not intended to limit this disclosure.

In an embodiment, the battery cells 24 of each battery module 22 are prismatic, lithium-ion cells. However, battery cells having other geometries (cylindrical, pouch, etc.), other chemistries (nickel-metal hydride, lead-acid, etc.), or both could alternatively be utilized within the scope of this disclosure.

The battery modules 22 and various other battery internal components (e.g., bussed electrical center, battery electric control module, wiring, connectors, etc.) may be housed inside of an enclosure assembly 28 of the traction battery pack system 18. Together, the battery modules 22 and the enclosure assembly 28 may establish a battery pack assembly 25 of the traction battery pack system 18.

The battery modules 22 may be arranged in one or more rows inside the enclosure assembly 28. Although only a single battery module 22 having twenty battery cells 24 is shown in FIG. 2, other configurations are considered possible. Accordingly, it should be appreciated that the traction battery pack system 18 could include a greater number of battery modules 22 and/or a greater or fewer number of battery cells 24 within the scope of this disclosure.

Although shown schematically, the enclosure assembly 28 may embody a multi-piece design that includes an enclosure cover 26 and an enclosure tray 30 that are joined together to establish an interior volume 34 for housing the battery module(s) 22. The size, shape, and overall configuration of the enclosure assembly 28 are not intended to limit this disclosure. In an embodiment, the enclosure assembly 28 provides a sealed enclosure around the battery module(s) 22 and other battery internal components of the battery pack assembly 25.

The traction battery pack system 18 may additionally include an immersion cooling system 32. As further detailed below, the immersion cooling system 32 may provide a closed loop flow circuit for thermally managing the battery cells 24 of the traction battery pack system 18. The immersion cooling system 32 may additionally provide vent gas exit flow paths for managing battery vent gases and other byproducts during certain operating conditions (e.g., battery thermal events) of the traction battery pack system 18. Although schematically shown, the various subcomponents of the immersion cooling system 32 can be fluidly interconnected by various conduits or passages such as tubes, hoses, pipes, etc.

The immersion cooling system 32 may be configured for directly contacting individual surfaces of the battery cells 24 by circulating a cooling fluid F along a flow path that extends through the interior volume 34 established by the enclosure assembly 28 of the battery pack assembly 25. In an embodiment, the cooling fluid F is a dielectric fluid. However, other types of cooling fluids could be utilized within the scope of this disclosure.

The immersion cooling system 32 may include an inlet pipe 40 and an outlet pipe 42 that are both fluidly connected to the interior volume 34. The inlet pipe 40 may be fluidly connected to a reservoir 44 that is configured for storing the cooling fluid F. A pump 46 may be operated to selectively circulate the cooling fluid F through the closed loop flow circuit of the immersion cooling system 32. In an embodiment, the pump 46 is located upstream from the inlet pipe 40 at a location that is between the inlet pipe 40 and the reservoir 44. However, the pump 46 could be located elsewhere within the scope of this disclosure. The pump 46 could be an electrically powered fluid pump or another type of pump within the scope of this disclosure.

A heat exchanger 48 (e.g., a fluid-to-air heat exchanger) may be disposed within a fluid line 50 that connects between the reservoir 44 and the pump 46. Thermal energy picked up from the battery cells 24 while the cooling fluid F passes through the interior volume 34 may be transferred from the cooling fluid F to ambient air within the heat exchanger 48. The reservoir 44, the pump 46, and the heat exchanger 48 may each be located outside of the enclosure assembly 28 of the battery pack assembly 25.

An injection shield 52 may be arranged within the interior volume 34 at a location between the battery cells 24 and the enclosure cover 26 of the enclosure assembly 28. However, other arrangements could be possible and are thus contemplated within the scope of this disclosure. The injection shield 52 may subdivide the interior volume 34 into a first interior volume section 54 and a second interior volume section 56. The first interior volume section 54 may be fluidly connected to the inlet pipe 40, and the second interior volume section 56 may be fluidly connected to the outlet pipe 42. In an embodiment, the second interior volume section 56 is a larger volume than the first interior volume section 54.

The first interior volume section 54 may be vertically above the second interior volume section 56 and may extend between the enclosure cover 26 and the injection shield 52, and the second interior volume section 56 may be vertically below the first interior volume section 54 and may extend between the injection shield 52 and the enclosure tray 30. Vertical, for purposes of this disclosure, is with reference to ground when the traction battery pack system 18 is installed on the electrified vehicle 10. In the exemplary embodiment, the battery module(s) 22 is located within the second interior volume section 56 of the interior volume 34.

The injection shield 52 may include a plurality of injection holes 58 formed therethrough. The injection holes 58 are configured to fluidly connect the first interior volume section 54 to the second interior volume section 56.

When the cooling fluid F is circulated along the flow circuit provided by the immersion cooling system 32, the pump 46 may be operated to selectively force the cooling fluid F through the inlet pipe 40 and then into the first interior volume section 54 of the interior volume 34. From the first interior volume section 54, the cooling fluid F may be injected through the injection holes 58 and into the second interior volume section 56 via a pressure build-up within the first interior volume section 54. Jets 38 of the cooling fluid F may thus be sprayed directly onto top surfaces 60 and terminals 36 of the battery cells 24.

Upon entering the second interior volume section 56, the cooling fluid F may be communicated within gaps 62 that extend between adjacent battery cells 24 of the battery module 22 and between the battery cells 24 and the surrounding structure provided by the enclosure assembly 28. The gaps 62 may be established by standoffs or other battery cell holding structures (not shown), for example. Via the gaps 62, the cooling fluid F can sweep over and around both major and minor side surfaces of the battery cells 24 prior to exiting the second interior volume section 56 through the outlet pipe 42.

The cooling fluid F may pick up heat from the battery cells 24 through convective heat transfer as it flows through the second interior volume section 56. Thermal energy picked up from the battery cells 24 while passing through the interior volume 34 may eventually be transferred from the cooling fluid F to ambient air within the heat exchanger 48.

The outlet pipe 42 may be fluidly connected to a liquid-gas separator 64. Gas may be separated from the cooling fluid F within the liquid-gas separator 64 and may then be exhausted to atmosphere through a gas outlet 66 as schematically shown in FIG. 2 at arrow 68. As schematically shown, the liquid-gas separator 64 may be located outside of the enclosure assembly 28 of the battery pack assembly 25 and may be positioned on an opposite side of the enclosure assembly 28 from the heat exchanger 48. The degassed cooling fluid F may be returned to the reservoir 44 within a fluid return line 70 that is fluidly connected to both the liquid-gas separator 64 and the reservoir 44.

The immersion cooling system 32 may additionally include a fluid manifold 72 and a plurality of runner pipes 74 that are fluidly connected to the fluid manifold 72. The fluid manifold 72 may extend outside of the enclosure assembly 28, and the runner pipes 74 may each fluidly connect the fluid manifold 72 to the second interior volume section 56 of the interior volume 34. The fluid manifold 72 may additionally be fluidly connected to the liquid-gas separator 64.

During normal operating conditions of the traction battery pack system 18, the fluid manifold 72 and the runner pipes 74 may cooperate to control the amount of cooling fluid F that can accumulate within the second interior volume section 56. Excess amounts of the cooling fluid F can be communicated to the liquid-gas separator 64 through the runner pipes 74 and the fluid manifold 72 (see, e.g., FIG. 3).

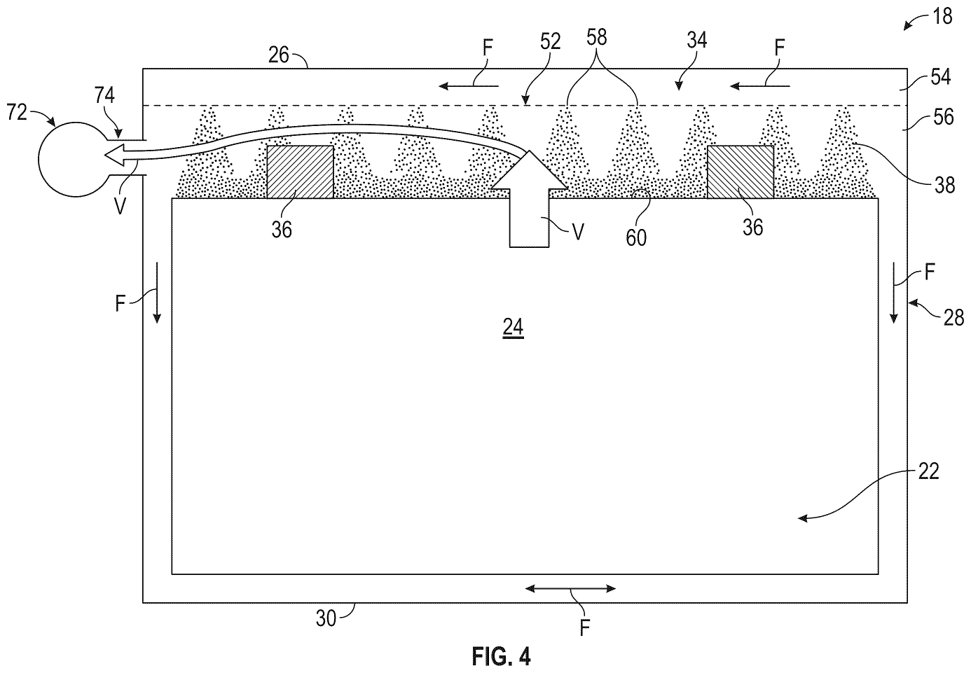

Referring now primary to FIG. 4, one or more of the battery cells 24 packaged within the traction battery pack system 18 can periodically release vent byproducts V, such as during an overcharge condition, an overdischarging condition, a short circuit, etc. The vent byproducts V can be released from the battery cells 24 through a vent port. Pressure increases within one of the battery cells 24 can cause the vent port to rupture, thereby creating a path for the vent byproducts V to be released from inside the battery cell 24 into the second interior volume section 56.

The released vent byproducts V can be quickly expelled from the traction battery pack system 18 through the runner pipes 74 and the fluid manifold 72. The vent byproducts V that travel through the fluid manifold 72 may be exhausted to atmosphere through the gas outlet 66 of the liquid-gas separator 64. The runner pipes 74 and the fluid manifold 72 thus establish a vent-gas exit flow path for quickly and efficiently expelling the vent byproducts V from the interior volume 34 with minimal fluid-gas flow mixing. The cooling fluid F is therefore not significantly heated by the vent byproducts V during thermal events, thereby reducing or even eliminating convective heat transfer that could be caused by the vent byproducts V during the thermal event. Moreover, excessive pressure build-up inside the enclosure assembly 28 of the battery pack assembly 25 may be prevented during the battery thermal event.

The exemplary traction battery pack systems of this disclosure include an immersion cooling system for providing enhanced battery cell thermal management and vent gas management. A specialized vent manifold and fluidly connected runner pipes cooperate to establish a vent-gas exit flow path capable of quickly and efficiently expelling battery vent byproducts with minimal fluid-gas intermixing. The proposed systems are capable of reducing or even eliminating convective heat transfer and excessive pressure build-up during battery thermal events.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack system, comprising:
an enclosure assembly that provides an interior volume;
an injection shield arranged to subdivide the interior volume of the enclosure assembly into a first interior volume section and a second interior volume section;
a battery module housed within the second interior volume section; and
the injection shield including a plurality of injection holes configured to spray a cooling fluid onto portions of the battery module.

2. The traction battery pack system as recited in claim 1, wherein the cooling fluid is a dielectric fluid.

3. The traction battery pack system as recited in claim 1, comprising a fluid manifold extending outside of the interior volume of the enclosure assembly.

4. The traction battery pack system as recited in claim 3, comprising a runner pipe fluidly connecting the fluid manifold to the second interior volume section.

5. The traction battery pack system as recited in claim 4, wherein the fluid manifold and the runner pipe cooperate to establish a dedicated vent gas exit flow path for expelling a battery vent byproduct from the enclosure assembly during a battery thermal event.

6. The traction battery pack system as recited in claim 1, wherein the plurality of injection holes are configured to spray the cooling fluid onto top surfaces of a plurality of battery cells of the battery module.

7. The traction battery pack system as recited in claim 1, wherein the interior volume is part of a closed loop cooling circuit of an immersion cooling system configured for circulating the cooling fluid.

8. The traction battery pack system as recited in claim 7, wherein the immersion cooling system includes an inlet pipe fluidly connected to the first interior volume section, and an outlet pipe fluidly connected to the second interior volume section.

9. The traction battery pack system as recited in claim 8, wherein the immersion cooling system includes a liquid-gas separator fluidly connected to the outlet pipe, and a reservoir fluidly connected to the inlet pipe.

10. The traction battery pack system as recited in claim 9, a comprising a heat exchanger arranged between the reservoir and the inlet pipe.

11. A traction battery pack system, comprising:
a battery pack assembly including a battery module housed within an enclosure assembly;
an injection shield arranged to subdivide an interior volume of the enclosure assembly into a first interior volume section and a second interior volume section, wherein the battery module is housed within the second interior volume section;
a fluid manifold extending outside of the interior volume of the enclosure assembly; and
a runner pipe fluidly connecting the fluid manifold to the second interior volume section.

12. The traction battery pack system as recited in claim 11, wherein the fluid manifold and the runner pipe cooperate to establish a dedicated vent gas exit flow path for expelling a battery vent byproduct from the battery pack assembly during a battery thermal event.

13. The traction battery pack system as recited in claim 11, wherein the injection shield is positioned between an enclosure cover of the enclosure assembly and a top surface of the battery module.

14. The traction battery pack system as recited in claim 11, wherein an inlet pipe is fluidly connected to the first interior volume section, and an outlet pipe is fluidly connected to the second interior volume section.

15. The traction battery pack system as recited in claim 14, comprising a reservoir fluidly connected to the inlet pipe.

16. The traction battery pack system as recited in claim 15, comprising a pump arranged between the reservoir and the inlet pipe.

17. The traction battery pack system as recited in claim 16, comprising a heat exchanger arranged between the pump and the reservoir.

18. The traction battery pack system as recited in claim 14, comprising a liquid-gas separator fluidly connected to the outlet pipe.

19. The traction battery pack system as recited in claim 18, wherein the liquid-gas separator is fluidly connected to the fluid manifold.

20. The traction battery pack system as recited in claim 18, wherein the liquid-gas separator is fluidly connected to a reservoir.
